(19) United States
(12) Patent Application Publication
(10) Pub. No.: US 2011/0232475 A1
(43) Pub. Date: Sep. 29, 2011

(54) INTEGRATED CYLINDER AND REVERSING ASSEMBLY MODULE OF A RECIPROCATING PNEUMATIC TOOL

(76) Inventor: Ching-Shun CHANG, Taichung City (TW)

(21) Appl. No.: 12/730,388

(22) Filed: Mar. 24, 2010

(51) Int. Cl. B25D 9/06

(52) U.S. Cl. 91/232; 173/114

(57) ABSTRACT

An integrated module of cylinder and reversing assembly of a reciprocating pneumatic tool is arranged between an air pressure guiding seat and a guiding cylinder of piston rod in the groove of a reciprocating pneumatic tool. The integrated module includes a cylinder body with a hollow body shaping an inner/external end and a chamber. The chamber is used for accommodating the piston of the piston rod. Several air flow ducts are laterally set at interval onto the chamber. A reversible actuating slot is recessed into the inner end of the cylinder body, and provided with a through-hole connected with the chamber of the cylinder body. A reversing brake block is accommodated movably into the reversible actuating slot. A spacing ring is accommodated into the reversible actuating slot to limit the reversing brake block. The cylinder and flow reversing body can be combined to simplify the structural members.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a reciprocating pneumatic tool, and more particularly to an innovative one which is configured with an integrated module of cylinder and flow reversing assembly.

2. Description of Related Art Including Information Disclosed Under 37 CFR 1.97 and 37 CFR 1.98.

Reciprocating pneumatic tools, such as pneumatic saws, pneumatic hammers and pneumatic cutters, are available with different functions depending on the shapes of the ends. According to the operating principle of reciprocating pneumatic tools, the source of air is firstly guided into the tool, then the opening/closing of air pressure is controlled by a control valve, and an actuating module is used for automatic reversing of air pressure, enabling the reciprocating movement of a piston rod together with the ends of tools (e.g.: saw blade, punch hammer).

In view of the structural configuration of the reciprocating pneumatic tool, the number of components affects directly the cost and efficiency of fabrication, processing and assembly, and the defective fabrication and assembly increase with the growing number of components. Thus, due attention must be paid to the technical issue of minimizing the structural members in the process of R&D and design.

As for the structural configuration of conventional reciprocating pneumatic tool similar to the present invention, Taiwan patent claim No. 96133970: “A Reciprocating Pneumatic Tool” can be referenced. The flow reversing assembly of prior art is structurally composed of a top plate, a principal pedestal and a base plate. The flow reversing assembly is superposed onto the surface of a cylinder. It is found from actual applications that, the flow reversing assembly of prior art must be provided with several overlapped plates, and then superposed onto a cylinder. Such an overlapping structure brings about much increase of fabrication, processing and assembly cost of structural members as well as poorer efficiency. Meanwhile a higher defect may occur against the performance and quality of finished products.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production and development of related products.

### BRIEF SUMMARY OF THE INVENTION

The “integrated module of cylinder and flow reversing assembly of reciprocating pneumatic tool” disclosed in the present invention comprises: a cylinder body, a reversible actuating slot, a reversing brake block and spacing ring. With this unique structural configuration, the present invention is characterized by that, a reversible actuating slot is recessed into the inner end of the cylinder body, so that the cylinder and flow reversing body can be combined to simplify the structural members, reduce the fabrication/processing cost, shorten the assembly time and minimize the defect with better applicability and industrial benefits.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective external view of the assembled reciprocating pneumatic tool of the present invention.

FIG. 2 shows an exploded perspective view of the reciprocating pneumatic tool of the present invention.

FIG. 3 shows an exploded perspective view of the integrated module of cylinder and reversing assembly of the present invention.

FIG. 4 shows a cross sectional view of the assembled reciprocating pneumatic tool of the present invention.

FIG. 5 shows a partially exploded cross sectional view of FIG. 4.

FIG. 6 shows a schematic view 1 of the air inlet of the present invention.

FIG. 7 shows a schematic view 2 of the air inlet of the present invention.

FIG. 8 shows a schematic view 3 of the air inlet of the present invention.

FIG. 9 shows a schematic view of the exhaust of the present invention.

FIG. 10 shows a cross sectional view along line B-B′ of FIG. 9.

FIG. 11 shows another schematic view of the spacing ring of the present invention.

### DETAILED DESCRIPTION OF THE INVENTION

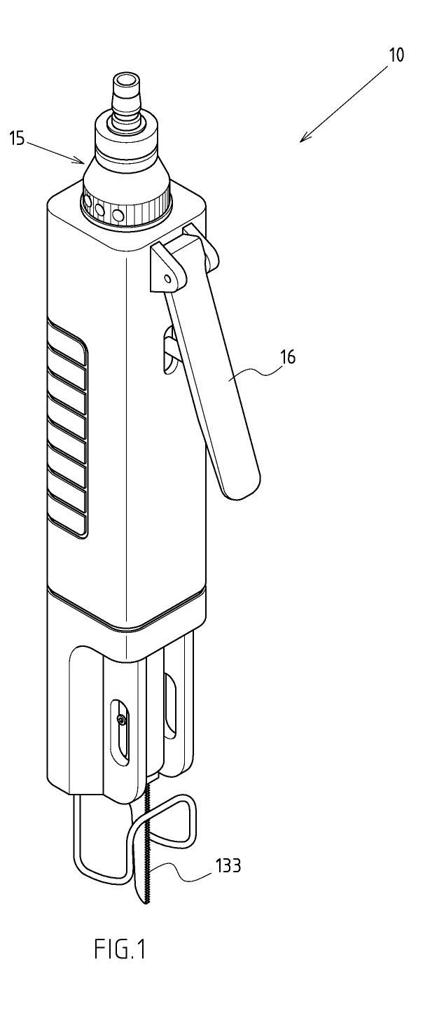

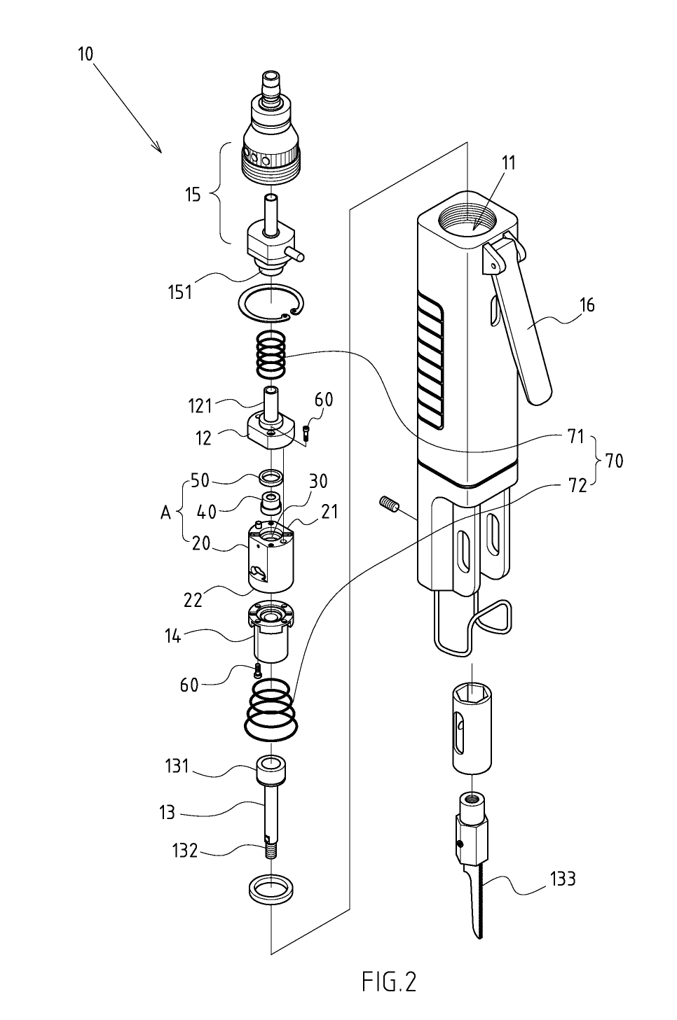

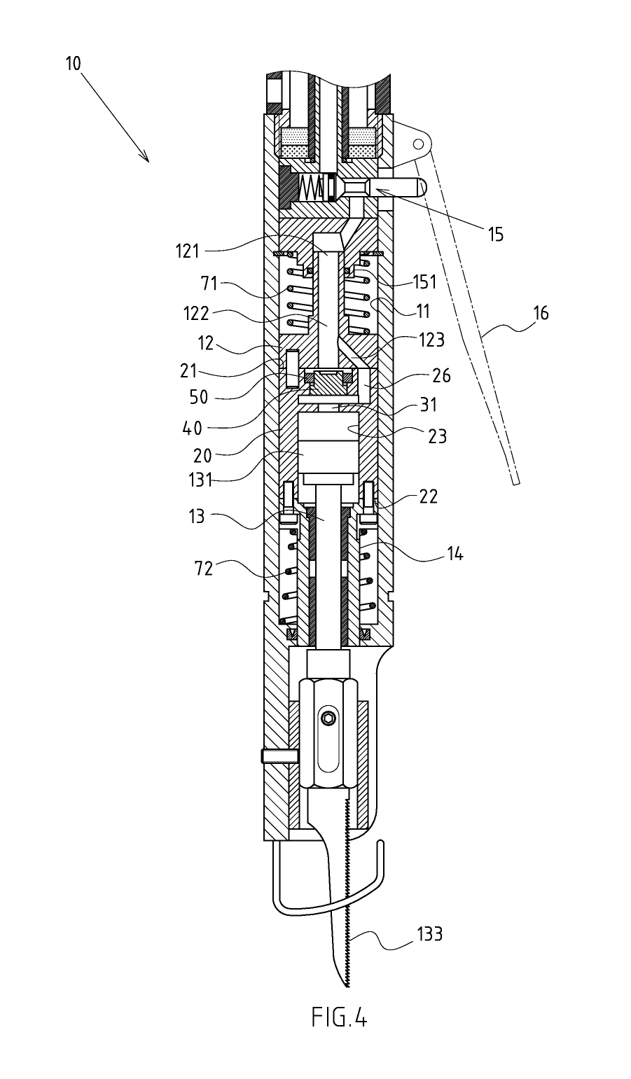

FIGS. 1-4 depict preferred embodiments of an integrated module of cylinder and reversing assembly of a reciprocating pneumatic tool of the present invention, which, however, are provided for only explanatory objective for patent claims. Said integrated module A of cylinder and reversing assembly is arranged between an air pressure guiding seat 12 and a guiding cylinder 14 of piston rod 13 in the groove 11 of reciprocating pneumatic tool 10. The piston rod 13 is provided with a piston 131 and a tool assembly portion 132. The tool assembly portion 132 is used for assembly and positioning of preset tool 133 (a saw blade in the preferred embodiment). The air pressure guiding seat 12 is provided with an air inlet end 121 that is connected with an air supply end 151 for an air pressure control module 15 of the reciprocating pneumatic tool 10. Moreover, the air pressure guiding seat 12 is internally fitted with a vertically arranged main air inlet guide hole 122 and an obliquely arranged secondary air inlet guide hole 123.

The integrated module A of cylinder and reversing assembly includes a cylinder body 20, a hollow body shaping an inner end 21, an external end 22 and a chamber 23. The chamber 23 is used for accommodating the piston 131 of the piston rod 13. Several air flow ducts 24 with air reversing functions are laterally set at interval onto the chamber 23 of the cylinder body 20. The inner end 21 is abutted onto the bottom of the air pressure guiding seat 12. The external end 22 is abutted onto the top of the guiding cylinder 14, and a reversing air inlet duct 140 set at the top of the guiding cylinder 14 (or the external end 22 of the cylinder body 20) can be linked to the bottom of the air flow duct 24 and chamber 23. Moreover, air vent 230 is opened laterally onto the chamber 23.

A reversible actuating slot 30 is recessed into the inner end 21 of the cylinder body 20, and provided with a through-hole 31 connected with the chamber 23 of the cylinder body 20. Moreover, the top of the aforementioned air flow duct 24 and the reversible actuating slot 30 are connected through a flow trough 25 into the inner end 21. The reversible actuating slot 30 and the secondary air inlet guide hole 123 of the air pressure guiding seat 12 are connected through a flow duct 26 set at the inner end 21 of the cylinder body 20.

A reversing brake block 40 is accommodated movably into the reversible actuating slot 30.

A spacing ring 50 is accommodated into the reversible actuating slot 30 to limit the reversing brake block 40.

Of which, the air pressure guiding seat 12 and cylinder body 20 are combined into a single body by a plurality of bolts 60.

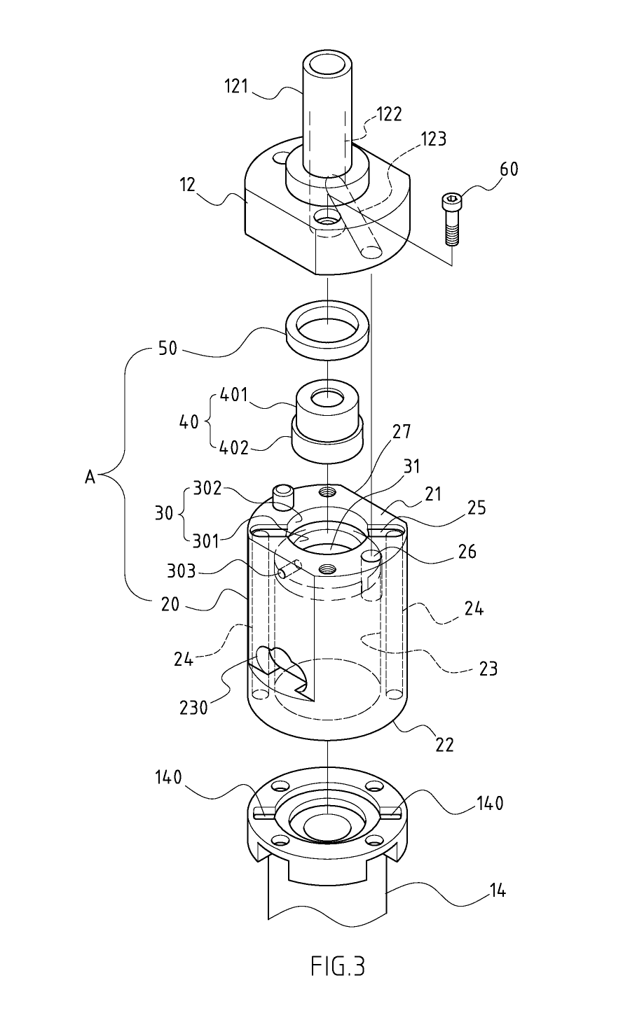

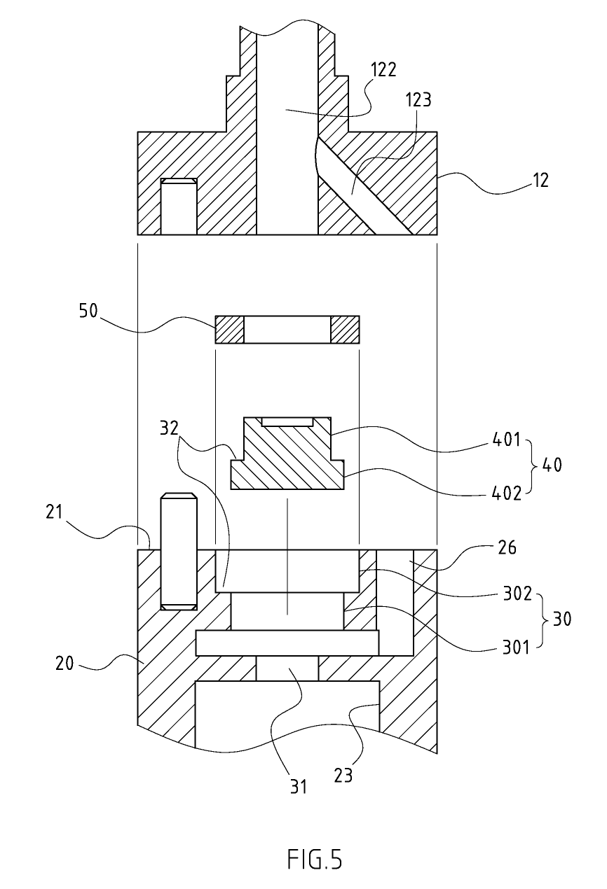

Referring to FIGS. 3 and 5, the reversible actuating slot 30 of a stepped recess space is defined into a pinched portion 301 and an flared portion 302, so that said through-hole 31 is placed at the center of the pinched portion 301. The reversing brake block 40 comprises a reduced portion 401 and an expanded portion 402. The expanded portion 402 is accommodated into the pinched portion 301 of the reversible actuating slot 30, whilst the reduced portion 401 is mated with the flared portion 302 of the reversible actuating slot 30. Then, a circular recessed space 32 (marked in FIG. 5) is formed between the end surface of reduced portion 401/flared portion 402 and the opening of the reversible actuating slot 30. Next, said spacing ring 50 is placed into the circular recessed space 32, so as to limit the reversing brake block 40. Moreover, at one side of the flared portion 302 of the reversible actuating slot 30, a vent hole 303 transversely passes through a lateral wall of the cylinder body 20, so as to release air accumulated in the reversible actuating slot 30 and maintain the smooth floatation of the reversing brake block 40.

A damper 70 is arranged within the groove 11 of the reciprocating pneumatic tool 10. Said damper 70 comprises a central buffer 71 (e.g. a spiral spring) set between air inlet end 121 of air pressure guiding seat 12 and air supply end 151 of air pressure control module 15, and a front buffer 72 (e.g. a spiral spring) set between the guiding cylinder 14 of the piston rod 13 and an end wall 110 of the groove 11.

Based upon above-specified structural configuration, the present invention is operated as follows:

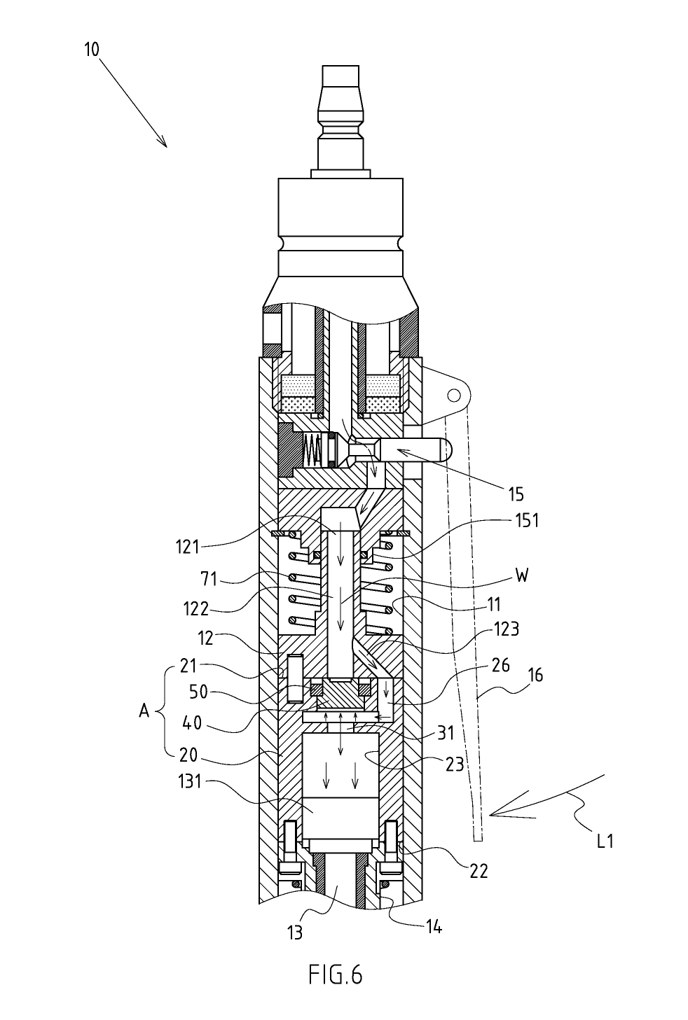

Referring to FIG. 6, said reciprocating pneumatic tool 10 is operated in such a manner that the control switch 16 is pressed (shown by arrow L1) to open air flow path of the air pressure control module 15. Then, air pressure W will pass through air supply end 151 of air pressure control module 15 and air inlet end 121 into air pressure guiding seat 12 and integrated module A of the cylinder and reversing assembly. With the help of air flow path of the integrated module A, the piston 131, piston rod 13 and the actuating tool are driven for rapid reciprocating movement with reference to the accompanying drawings.

Referring firstly to FIG. 6, when air pressure W is guided from air pressure guiding seat 12 into the integrated module A of cylinder and reversing assembly, it passes through secondary air inlet guide hole 123 and flow duct 26 into the reversible actuating slot 30. In such case, air pressure W will push the reversing brake block 40 upwards to drive the top of the reversing brake block 40 to close the main air inlet guide hole 122, on the other hand, air pressure W passes the through-hole 31 into the chamber 23 of the cylinder body 20 so as to push the piston 131 downwards.

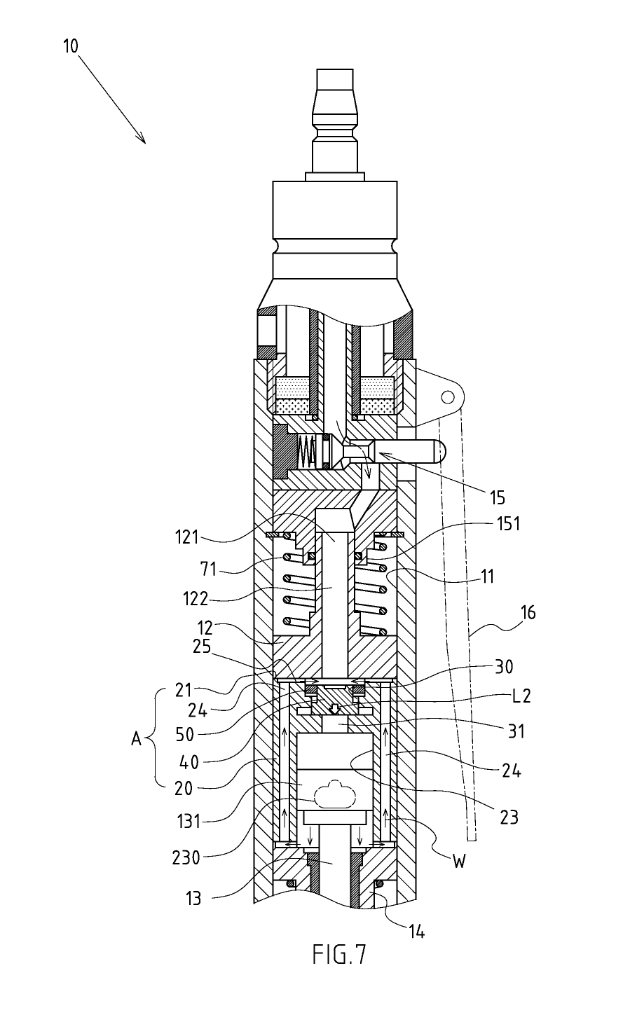

Referring also to FIG. 7, the sectional position is located at the air flow duct 24 of the cylinder body 20. When the piston 131 is pushed downwards, air in the lower space of the chamber 23 will pass through the reversing air inlet duct 140 of the guiding cylinder 14 and then through the flow trough 25 into the upper part of the reversible actuating slot 30, thus pushing the reversing brake block 40 downwards (shown by arrow L2).

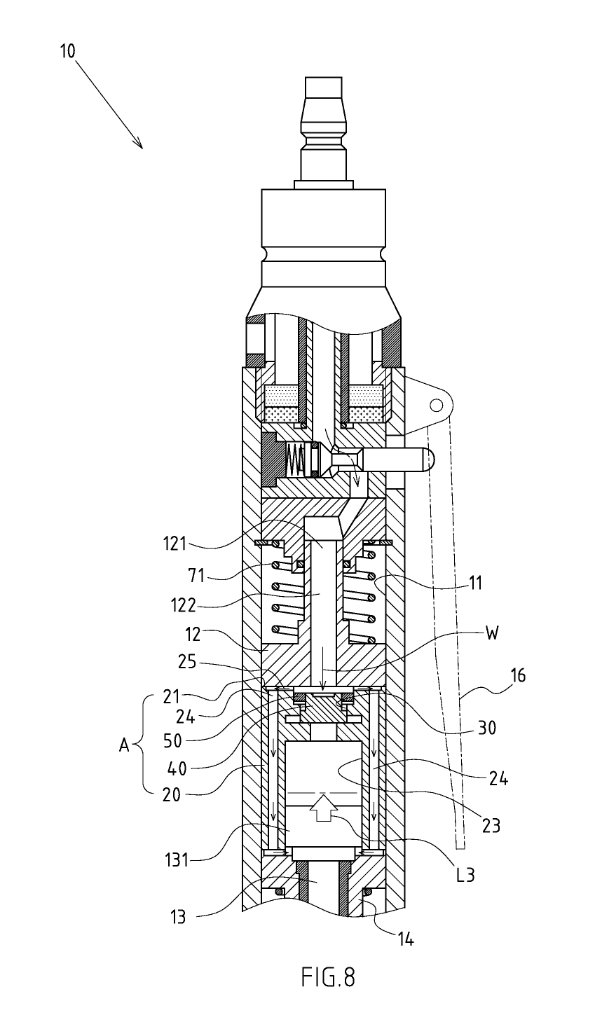

Referring also to FIG. 8, when the reversing brake block 40 is pushed downwards by air pressure W, air pressure W of main air inlet guide hole 122 can enter into the reversible actuating slot 30, then pass through the flow trough 25, air flow duct 24 and air inlet duct 140 into the lower space of the chamber 23, thus pushing the piston 131 upwards (shown by arrow L) for reversing movement.

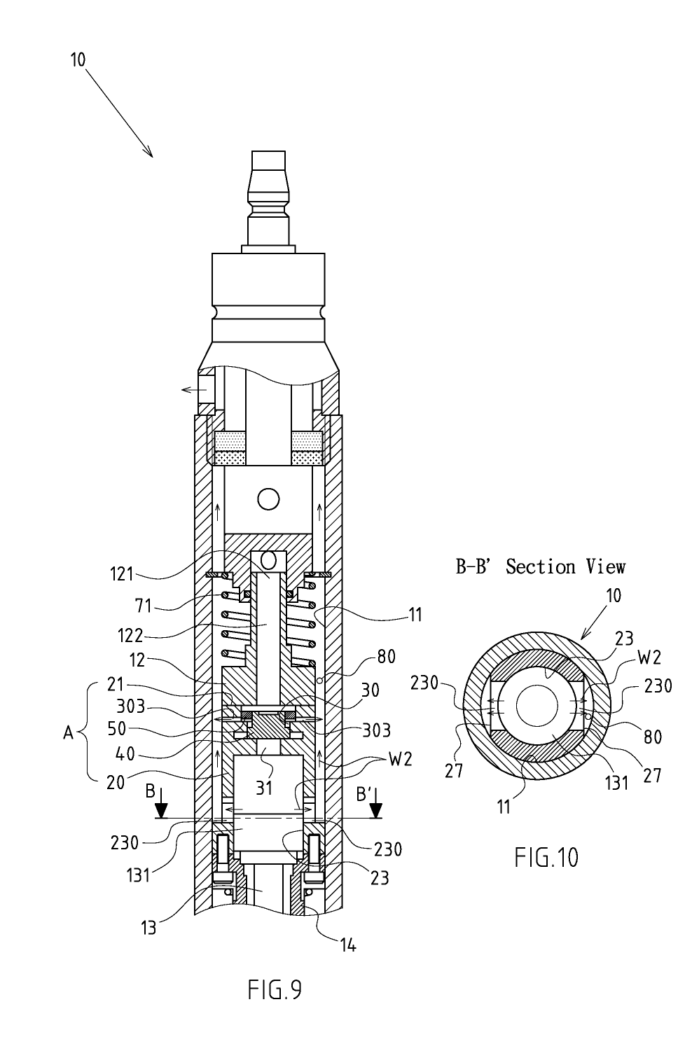

Referring also to FIGS. 9 and 10, when the piston 131 is pushed downwards to the bottom, the exhaust air flow W2 will be discharged from air vent 230 at one side of the chamber 23 to an exhaust duct 80 preset at exterior of the cylinder body 20. Said exhaust duct 80 is structured in such a way that the peripheral wall of the cylinder body 20 is configured into a cylindrical shape with two truncated sides 27 (marked in FIGS. 3, 10), whilst the inner wall of the groove 11 of the reciprocating pneumatic tool 10 is configured into a cylindrical shape accordingly, so that said exhaust duct 80 is formed between the truncated side 27 of the cylinder body 20's peripheral wall and the inner wall of the cylindrical groove 11.

The core configuration of the present invention lies in that, the main body of conventional cylinder and reversing assembly is combined uniquely to simplify the structural members without changing the functions of guiding, reversing air and actuating the piston.

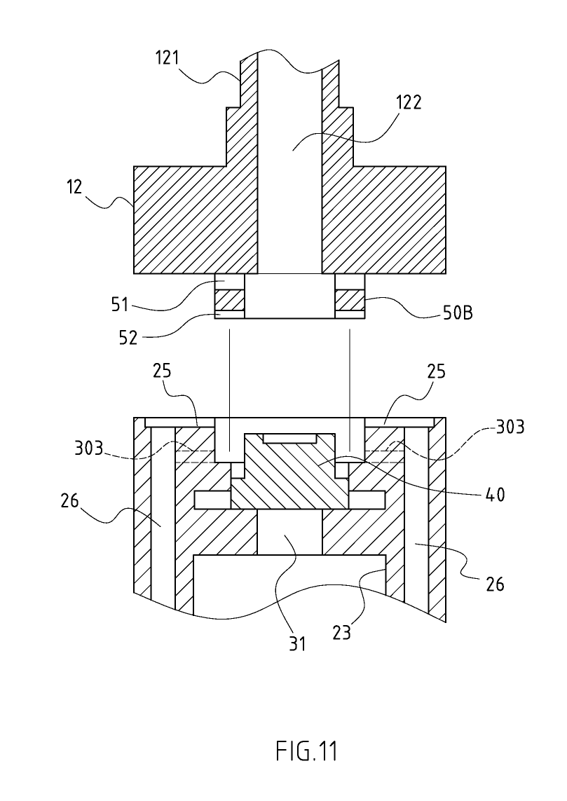

Furthermore, the spacing ring 50 can be individually fabricated and then assembled into the reversible actuating slot 30, as shown in FIG. 3. Alternatively, the spacing ring 50B can be protruded integrally from the bottom of the air pressure guiding seat 12, as shown in FIG. 11. The integrated spacing ring 50B must be reserved with air ducts 51, 52, of which the upper air duct 51 allows to maintain a smooth air flow state between the flow trough 25 of the inner end 21 of the cylinder body 20 and the reversible actuating slot 30. The lower air duct 52 allows for maintaining a smooth flow state between the vent hole 303 and reversible actuating slot 30, thus avoiding the jamming of air flow path. Besides, the lower air duct 52 can be formed from upward reduction of the bottom height of the spacing ring 50B.

I claim:

1. An integrated module A of cylinder and reversing assembly of a reciprocating pneumatic tool, which is arranged between an air pressure guiding seat and a guiding cylinder of piston rod in the groove of reciprocating pneumatic tool; the piston rod is provided with a piston and a tool assembly portion; the air pressure guiding seat is provided with an air inlet end that is connected with an air supply end for an air pressure control module of the reciprocating pneumatic tool; moreover, the integrated module A of cylinder and reversing assembly comprising:
a cylinder body, a hollow body shaping an inner end, an external end and a chamber; the chamber is used for accommodating the piston of the piston rod; several air flow ducts are laterally set at interval onto the chamber of the cylinder body;
a reversible actuating slot, recessed into the inner end of the cylinder body, and provided with a through-hole connected with the chamber of the cylinder body;
a reversing brake block, accommodated movably into the reversible actuating slot;
a spacing ring, accommodated into the reversible actuating slot to limit the reversing brake block.

2. The structure defined in claim 1, wherein said air pressure guiding seat and cylinder body are combined into a single body by a plurality of bolts.

3. The structure defined in claim 1, wherein the reversible actuating slot of a stepped recess space is defined into a pinched portion and an flared portion, so that said through-hole is placed at the center of the pinched portion; the reversing brake block comprises of a reduced portion and an expanded portion; the expanded portion is accommodated into the pinched portion of the reversible actuating slot, whilst the reduced portion is mated with the flared portion of the reversible actuating slot; then a circular recessed space is formed between the end surface of reduced portion/flared portion and the opening of the reversible actuating slot; next, said spacing ring is placed into the circular recessed space, so as to limit the reversing brake block; moreover, a vent hole set at one side of the flared portion transversely passes through a lateral wall of the cylinder body.

4. The structure defined in claim 1, wherein the spacing ring can be individually fabricated and then assembled into the reversible actuating slot.

5. The structure defined in claim 1, wherein the spacing ring can also be protruded integrally from the bottom of the air pressure guiding seat; and air ducts must be reserved onto the preset location of the integrated spacing ring.

6. The structure defined in claim 1, wherein a damper is arranged within the groove of the reciprocating pneumatic tool; said damper comprises of a central buffer set between air inlet end and air supply end of air pressure control module, and a front buffer set between the guiding cylinder of the piston rod and an end wall of the groove.

7. The structure defined in claim 1, wherein said air pressure guiding seat is internally fitted with a vertically arranged main air inlet guide hole and an obliquely arranged secondary air inlet guide hole; a flow trough is set onto the inner end of the cylinder body to connect the top of the air flow duct and the reversible actuating slot; the reversible actuating slot and the secondary air inlet guide hole of the air pressure guiding seat are connected through a flow duct set at the inner end of the cylinder body.

8. The structure defined in claim 1, wherein a reversing air inlet duct set at the top of the guiding cylinder or the external end of the cylinder body can be linked to the bottom of the air flow duct and the chamber; a reversing air inlet duct set at the top of the guiding cylinder or the external end of the cylinder body can be linked to the bottom of the air flow duct and the chamber.

9. The structure defined in claim 1, wherein the peripheral wall of the cylinder body is designed into a cylindrical shape with truncated sides, whilst the inner wall of the groove of the reciprocating pneumatic tool is designed into a cylindrical shape accordingly, so that an exhaust duct is formed between the truncated side of the cylinder body's peripheral wall and the inner wall of the cylindrical groove.
